(19) United States
(12) Patent Application Publication
(10) Pub. No.: US 2005/0017471 A1
(43) Pub. Date: Jan. 27, 2005

(54) Steering with triple linkage suspension having steering adjusted camber

(76) Inventor: Matthew Kim, Walnut Creek, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/864,557

(22) Filed: Jun. 8, 2004

Related U.S. Application Data
(60) Provisional application No. 60/477,473, filed on Jun. 9, 2003.

(51) Int. Cl. B62D 17/00

(52) U.S. Cl. 280/86.751

(57) ABSTRACT

This invention relates to steering systems having triple linkage suspensions. More specifically, provision is made for the steering linkage assembly to interact with the front and rear suspension linkages to adjust wheel camber responsive to steering.

### CROSS-REFERENCES TO RELATED APPLICATIONS

This application claims the benefit of Provisional Patent Application 60/477473 filed Jun. 9, 2003 entitled STEERING WITH TRIPLE LINKAGE SUSPENSION HAVING STEERING ADJUSTED CAMBER.

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not applicable

This invention relates to steering of automobiles. Specifically, this invention discloses a mechanical steering linkage which cants steered wheels to the outside of a turn to provide for evenly distributed tire distribution during high speed turns, typically encountered by racing cars making turns.

### BACKGROUND OF THE INVENTION

In four-wheel, steered vehicles, so-called double linkage or “wishbone” suspensions for the steered forward wheels of such vehicles are well known. In understanding the double linkage suspensions, conventional steering will first be described. Thereafter, the interaction of a double linkage on such conventional steering will be set forth.

In conventional steering, a wheel hub is mounted for rotation in a vertical plane about and normal to a horizontally disposed steering spindle. This steering spindle is in turn connected by a vertical kingpin to a steering knuckle. Rotation of the steering spindle about the steering knuckle on the vertical kingpin occurs through a steering linkage assembly. The steering linkage assembly includes a tie rod arm fixed to and rotating with the steering spindle and a tie rod actuated by the vehicle steering wheel. Movement of the tie rod causes rotation of the tie rod arm with rotation of the steering spindle about the vertical kingpin. As the steering spindle rotates, the generally vertical plane of wheel hub rotation turns to steer the vehicle.

The double linkage suspension of conventional steering is well known. Upper and lower links are utilized for support at the steering knuckle. Typically, the outer ends of such links are typically pinned to the steering knuckle. The inner ends of such links are attached to the vehicle. Thus, the steering knuckle can move upwardly and downwardly with respect to the vehicle body while being maintained in the generally vertical relationship relative to the vehicle. Preferably, at least one of the links is connected by a suspension system to the vehicle. This suspension system supports the vehicle and expands and contracts to isolate and absorb shock transmitted to the steering knuckle through the wheel. Thus, shock at the wheel is prevented from reaching the vehicle by the shock absorbing suspension system.

Sometimes, such double linkage suspension systems are characterized by the term “wishbone.” When the links are viewed from above towards the ground over which the vehicle travels, the links have a generally triangular shape. The apex end of such triangularly shaped links is attached to the steering knuckle. The base end of such triangularly shaped links is attached to the vehicle. This triangular shape imparts structural rigidity to the steering suspension. The upper and lower links of “wishbone” suspensions in modern production cars take the shape of either triangular or linear forms, depending on the space available within the body of the car. This serves as the connection to the vehicle suspension system. Open wheel racecars typically do not have such space restraints, and therefore both the upper and lower links assume the traditional double “wishbone” configuration.

The upper and lower links can vary in length between the steering knuckle and the vehicle. Where these links are other than even in length, the vertical disposition of the steering knuckle and the vertical kingpin can change with up-and-down movement. Consequently, the steering spindle will vary from the horizontal. This variance from the horizontal imparts to the plane of wheel rotation the variance from the vertical. This variance of the plane of wheel rotation from the vertical is known as “camber.”

It is important to note that in such systems variance of the camber is solely a function of the change of position of the steering knuckle relative to the vehicle. This change of position of the steering knuckle relative to the vehicle is in turn controlled by the suspension between the links and the vehicle. It is especially important to note for the purposes of this disclosure that this prior art change of camber is in no way responsive to this steering of the vehicle.

In the usual case, when the vehicle is steered and in the absence of dynamic forces on the links and suspension, the plane of rotation of the wheel remains vertical. No camber is imparted to the steered wheel. Thus, for four-wheel vehicles, the steered wheels only change in camber responsive to changing weight dynamics on the steered wheels.

The camber of a conventionally steered four-wheel vehicle is to be contrasted with a two wheel vehicle, such as a motorcycle. As is well-known, two wheel vehicles “lean into” their turns. Thus, the camber of the wheels changes responsive to steering (and speed) of such vehicles. In the usual case, this change of camber is highly advantageous. Specifically, the tires of such two wheel vehicles are designed with curvilinear cross-sections so that this changing camber produces an optimum footprint with respect to the road to enable a maximum grip relative to the road.

The function of this grip can be easily understood.

When a motorcycle travels on a straight-line path, only the vertical weight of the motorcycle on the steered and driven motorcycle wheels reacts through the tires to the motorcycle. The motorcycle wheels are conventionally, vertically loaded. When a motorcycle turns on a curved path, the vertical weight of the motorcycle on this steered and driven motorcycle wheels has added the dynamic forces caused by those dynamic forces necessary to turn the motorcycle. Simply stated, when a motorcycle turns centrifugal force must be overcome in turning. Thus, the wheels lean into the turn and react both to the vertical weight of the motorcycle and the centrifugal force necessary to turn the motorcycle.

I have discovered that it would be highly desirable to vary the camber of this steered front and rear wheels of a four-wheel vehicle in a manner analogous to the wheels of a steered motorcycle. In so far as the prior art has not suggested such a camber response of steered wheels on four-wheel vehicles, invention is claimed.

### BRIEF SUMMARY OF THE INVENTION

In a double linkage steering system for a four-wheel vehicle, linkage length relative to the vehicle is changed responsive to steering. Specifically, upon the wheel turning toward the inside of the vehicle, the tie rod extends to turn the wheel plane of rotation toward the inside of the vehicle. At the same time, the steering pulls the upper linkage toward the vehicle causing this steering knuckle to tilt toward the vehicle. The horizontal disposition of the wheel spindle changes with the steering knuckle tilt. Camber angles of the steered wheels are altered with the plane of wheel rotation, tilting at the top toward or away from the vehicle. This same camber angle can be imparted to rear non-steered wheels. As a result, wheel camber responsive to wheel steering analogous to a two wheel vehicle the camber occurs.

### BRIEF DESCRIPTION OF THE DRAWINGS

FIG. 1A is a prior art front elevation view of a conventional double linkage vehicle suspension system;

FIG. 1B is a prior art plan view of the conventional double linkage vehicle suspension system shown in FIG. 1A;

FIG. 2A is a rear elevation of one wheel of the steering system of this invention illustrating the steering tie rod and upper linkage imparting vertical camber to a spindle mounted hub on the steering system;

FIG. 2B is a rear elevation of one wheel of the steering system of this invention according to FIG. 2A illustrating the suspension system experiencing a vertical load, such as a bump or a dip in the road with no steering input or lateral load imposed and no change in camber allowing the wheel to remain normal to the road, maximizing the tire's contact patch for this condition;

FIG. 2C is a rear elevation of the outboard, laden wheel of the steering system of this invention according to FIG. 2B illustrating the suspension system experiencing a vertical and lateral load such as a change in direction with steering tie rod turning the spindle mounted hub by extending away from the vehicle and pulling the upper steering linkage in towards the vehicle to both increase the turn and increase the camber angle, leaning the bottom of this steered wheel to the outside the turn;

FIG. 2D is a rear elevation of the inboard, unladen wheel of the steering system of this invention according to FIG. 2B illustrating the suspension system experiencing a vertical and lateral load such as a change in direction with the steering tie rod turning the spindle mounted hub by pulling it towards the vehicle and extending the upper steering linkage away from the vehicle to both increase the turn and increase the camber angle, leaning the bottom of this steered wheel to the outside the turn;

FIG. 3A is a front elevation of one wheel of the steering system of this invention illustrating the steering tie rod and upper linkage imparting vertical camber to a spindle mounted hub on the steering system;

FIG. 3B is a front elevation of one wheel of the steering system of this invention according to FIG. 3A illustrating the suspension system experiencing a vertical load, such as a bump or a dip in the road with no steering input or lateral load imposed in this condition, no change in camber which allows the wheels to remain normal to the road, maximizing the tire's contact patch for this condition;

FIG. 3C is a front elevation of the outboard, laden wheel of the steering system of this invention according to FIG. 3B illustrating the suspension system experiencing a vertical and lateral load such as a change in direction with steering tie rod turning the spindle mounted hub by extending away from the vehicle and pulling the upper steering linkage in towards the vehicle to both increase the turn and increase the camber angle, leaning the bottom of this steered wheel to the outside the turn; and

FIG. 3D is a perspective front elevation similar to FIG. 3C changing the angle of view of the wheel club to illustrate steered deflection and changed camber.

FIG. 3E is a rear elevation of the inboard, unladen wheel of the steering system of this invention according to FIG. 3B illustrating the suspension system experiencing a vertical and lateral load such as a change in direction with the steering tie rod turning the spindle mounted hub by pulling it towards the vehicle and extending the upper steering linkage away from the vehicle to both increase the turn and increase the camber angle, leaning the bottom of this steered wheel to the outside the turn;

FIG. 4 is a plan view of the invention shown in FIGS. 2A-2D and 3A-3E.

FIG. 5A is an elevation of the front left and right suspensions according to FIG. 3C and FIG. 3E illustrating the suspension system experiencing a change in direction to the right with the suspension system leaning the tires into the corner, much like a motorcycle.

FIG. 5B is an elevation of the rear elevation of the rear left and right suspensions illustrating the suspension system experiencing a change in direction to the right with the suspension system leans the tires into the corner, much like a motorcycle.

FIG. 5C is a rear view of the front and rear suspensions illustrating the suspension system experiencing a change in direction to the right with the front and rear suspension systems are working in tandem to lean the tires into the corner, much like a motorcycle.

FIG. 6A is a prior art front elevation diagram of a conventional double linkage vehicle suspension system and plan views of the tires' contact patches, showing the vehicle at rest and the contact patches displaying the maximum surface area.

FIG. 6B is a prior art front elevation diagram of a conventional double linkage vehicle suspension system and plan views of the tires' contact patches according to FIG. 6A showing the vehicle under vertical loading, and the contact patches displaying a compromised tire contact patch due to the negative camber built into the prior art design.

FIG. 6C is a prior art front elevation diagram of a conventional double linkage vehicle suspension system and plan views of the tires' contact patches according to FIG. 6A showing the vehicle under vertical loading and lateral loading, and the laden wheel displaying a maximum contact patch due to the negative camber and the bending and distortion of the linkages and tire caused by lateral forces, while the unladen wheel is displaying a compromised tire contact patch due to the negative camber built into the prior art design.

FIG. 6D is a front elevation suspension diagram of this invention and plan views of the tires' contact patches, showing the vehicle at rest and the contact patches displaying the maximum surface area.

FIG. 6E is a front elevation suspension diagram of this invention and plan views of the tires' contact patches according to FIG. 6D showing the vehicle under vertical loading, and the contact patches displaying no change in camber, thus providing the maximum contact patch.

FIG. 6F is a front elevation suspension diagram of this invention and plan views of the tires' contact patches according to FIG. 6D showing the vehicle under vertical loading and lateral loading, and the both wheels displaying maximum contact patches due to the cambers favorably generated to counteract any bending and distortion of the linkages and tire caused by lateral forces.

### DETAILED DESCRIPTION OF THE INVENTION

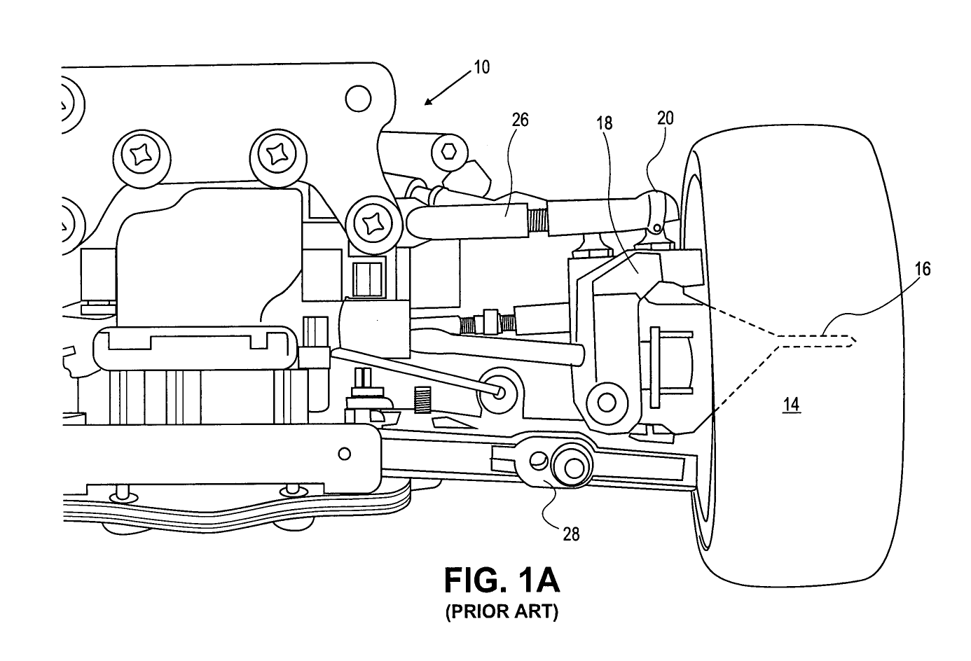

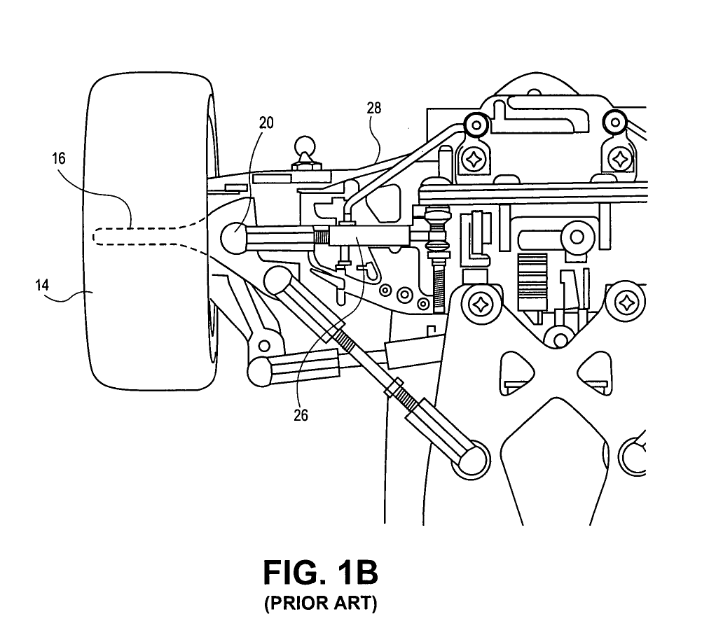

Referring to FIGS. 1A and 1B, wheel 14 is shown rotating about spindle 16 at a hub 15. Spindle 16 is pivotally mounted to steering knuckle 18 via a kingpin 20. Spindle 16 has upper arm 26 linked to lower arm 28. Tie rod 32 is responsive to the vehicles the steering system moving towards and away from vehicle 10. Since spindle 16 is substantially horizontal, it will be understood that wheel 14 rotates in a generally vertical plane.

Referring to FIG. 1A, upper link 26 and lower link 28 can be seen extending between steering knuckle 18 and vehicle 10. It will be seen that respective links 26, 28 are essentially the same length. As can be seen in FIG. 1B, lower link 28 is triangular in plan with the apex end of the link pinned to the lower portion of the steering knuckle 18. It will be seen that suspension 30 interconnects lower link 28 and vehicle 10. It provides for the support of this steered wheel 14 relative to the vehicle 10.

In the system of FIGS. 1A and 1B, camber of wheel 14 is essentially constant with up-and-down movement of steering knuckle 18. That is to say, camber can only be changed substantially dependent upon the lengths of the upper link 26 and lower link 28 with respect to one another. Further, camber will not change relative to the steering of vehicle 10.

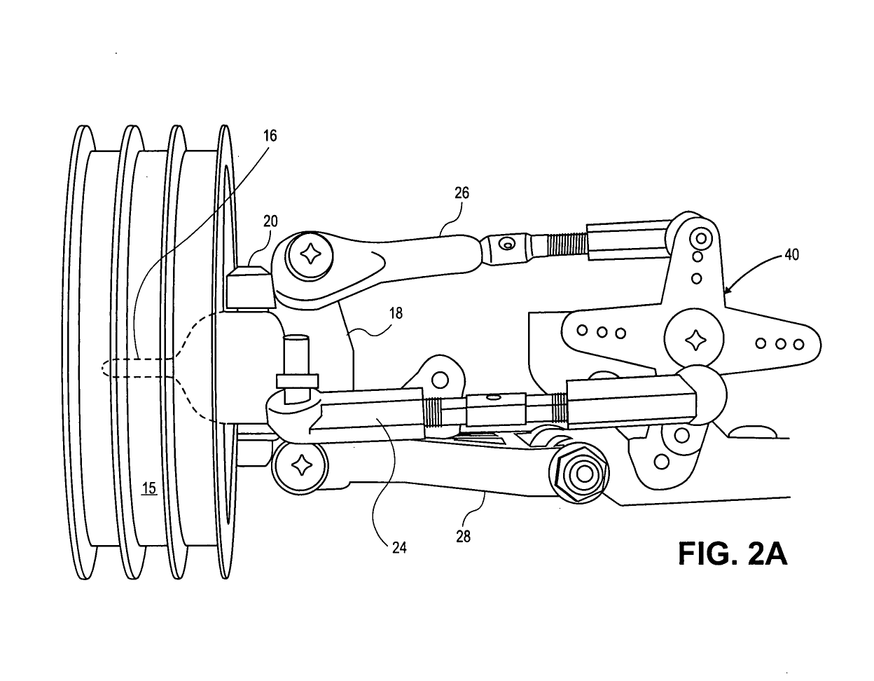

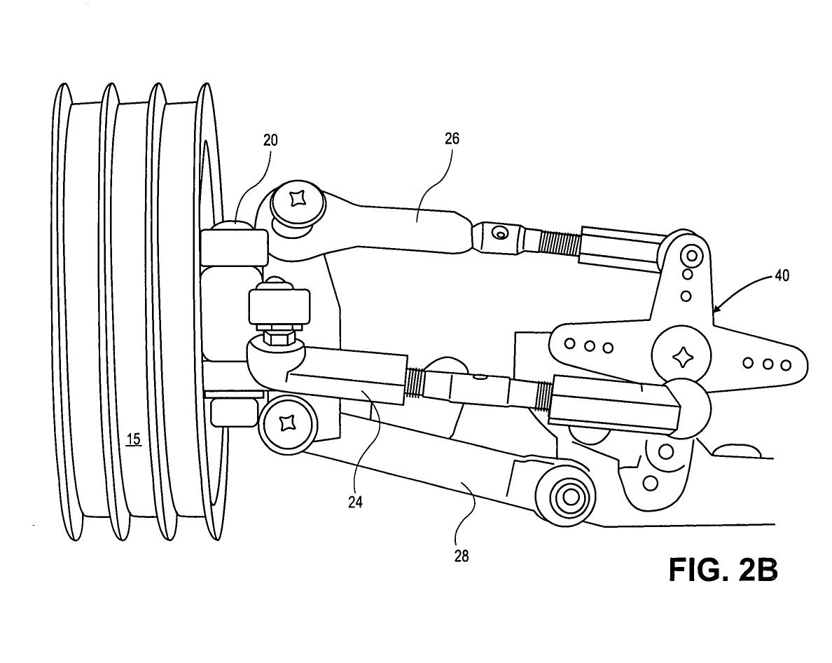

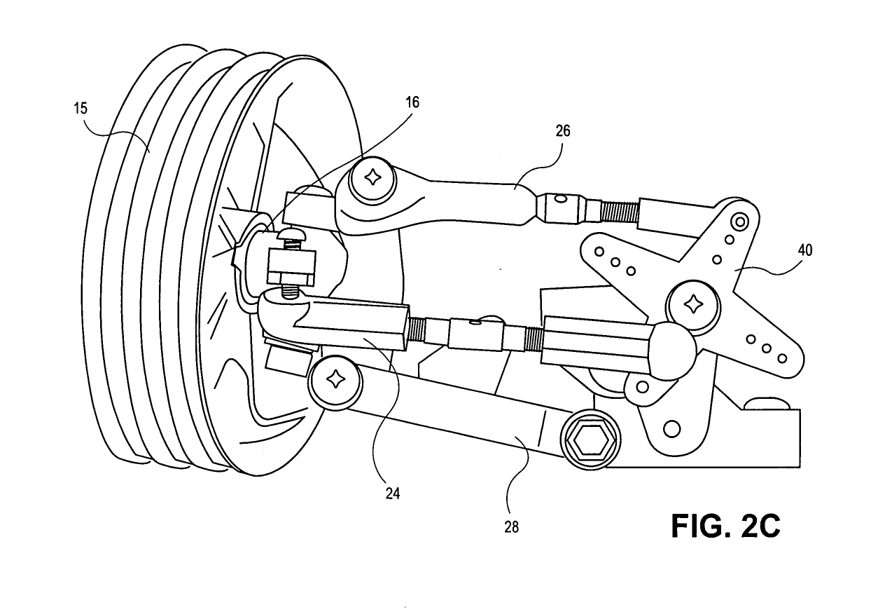

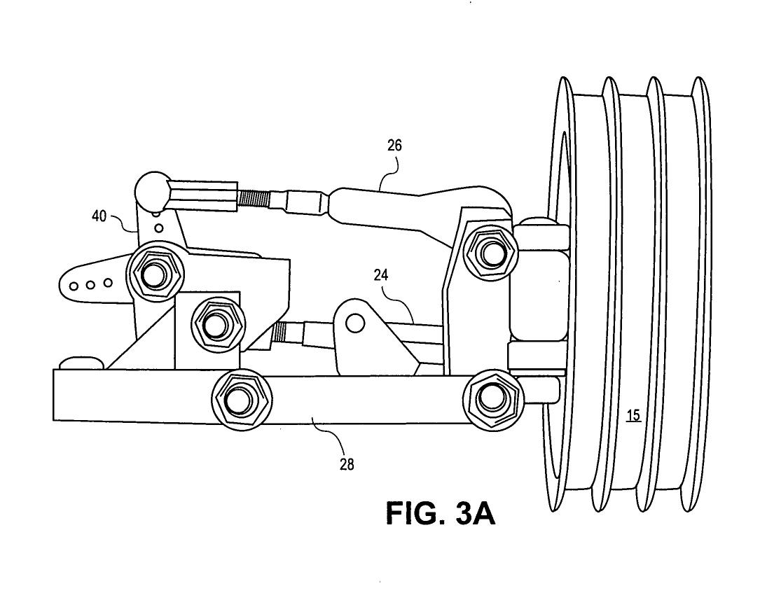

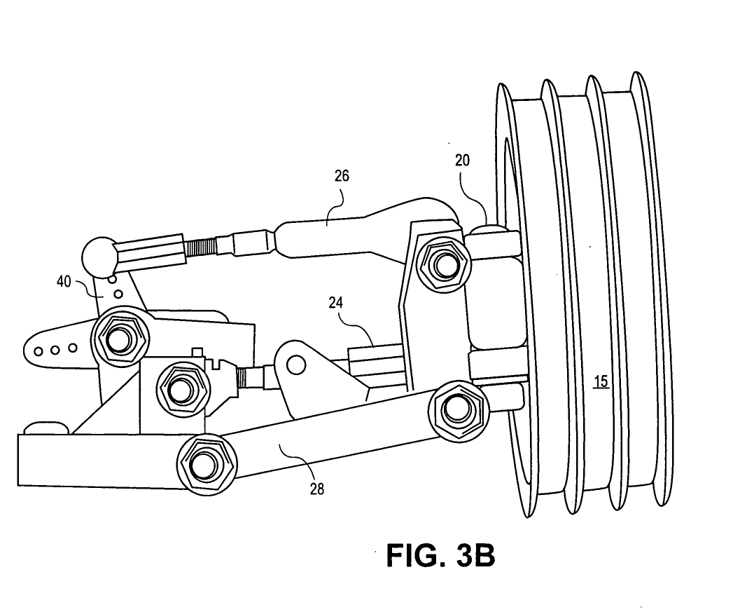

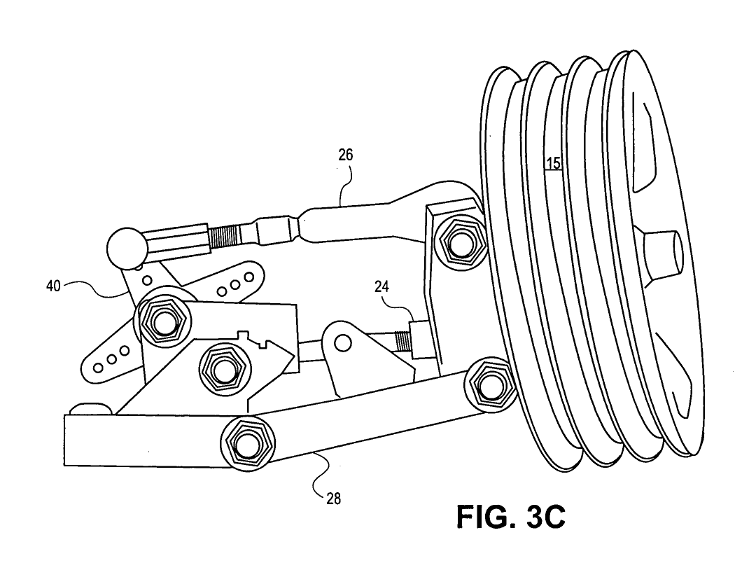

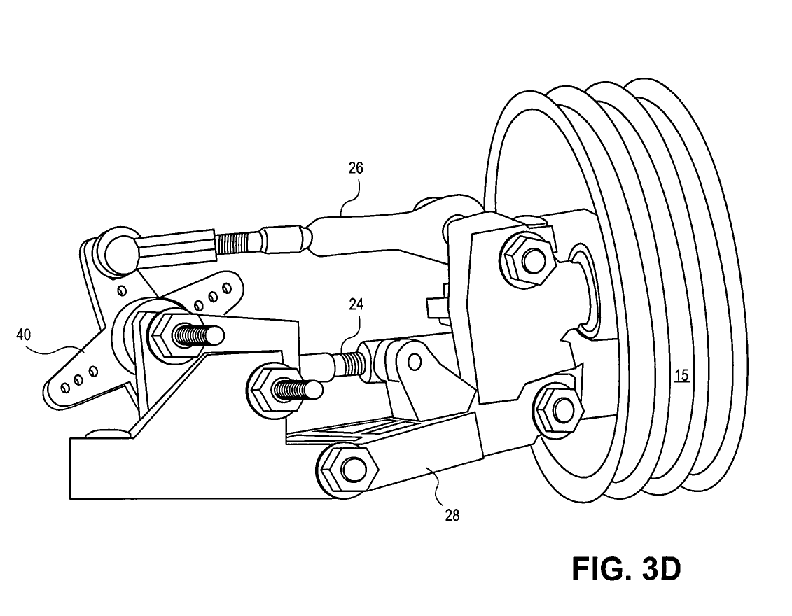

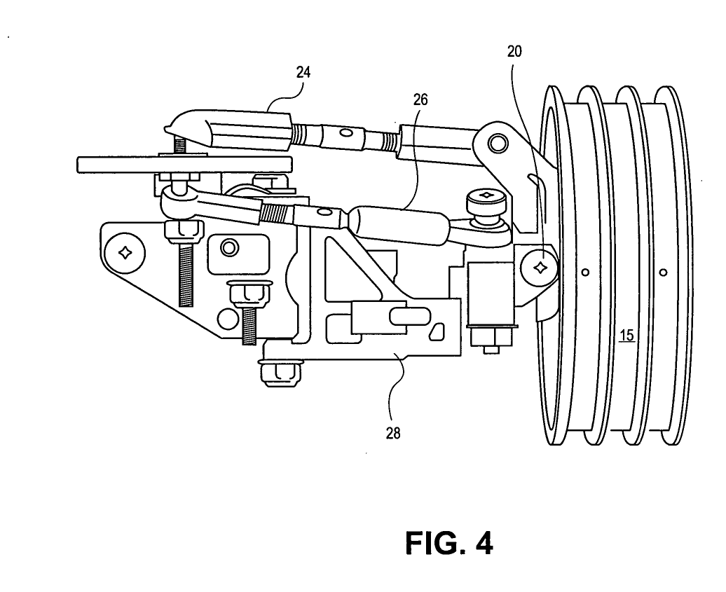

Referring to FIGS. 2A and 3A, wheel 14 has been removed exposing hub 15. Hub 15 is shown with spindle 16 shown in phantom. Steering mechanism 40 from vehicle 10 (not shown in figure) is shown in the form of star wheel 40. Star wheel 40 as two linkages attached thereto. First, tie rod 24 connects to tie rod arm 26. By turning steering knuckle 18 conventionally about vertical kingpin 20, conventional steering of hub 15 (and spindle 16) occurs. Second, attached to star wheel 40, upper link 26 is attached to the upper portion of the star wheel 40. It will be noted, that on rotation of star wheel 40 in the clockwise (FIG. 2A front elevation) direction, tie rod 24 will be extended. Hub 15 will turn towards the inside of the vehicle 10. At the same time, link 26 will be pulled toward vehicle 10. The knuckle 18 will lean the top portion to and towards the vehicle (not shown in this view). This will cause hub 15 (steered to the inside of the vehicle) to move at the bottom of hub 15 away from the vehicle 10. The results will be a change in camber of hub 15. These movements can be observed in FIGS. 2C, 3C, and 3D.

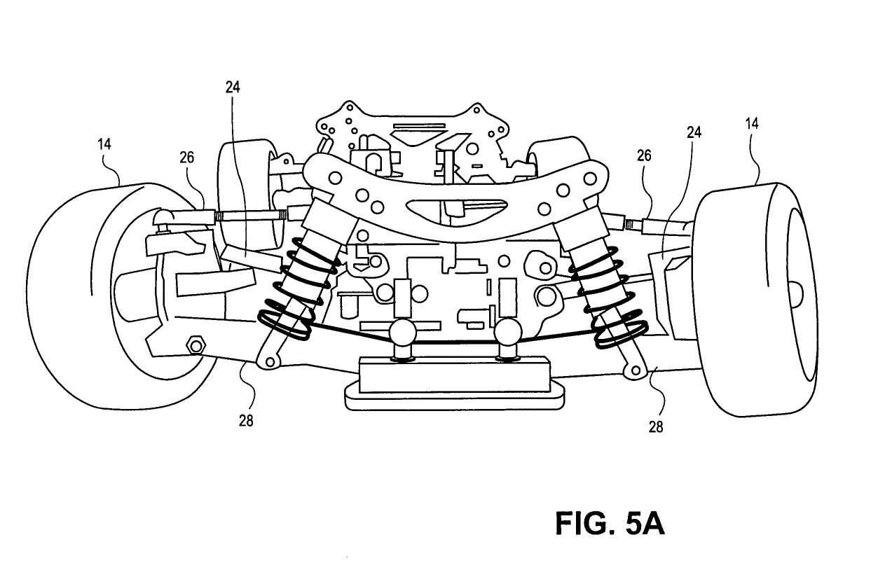

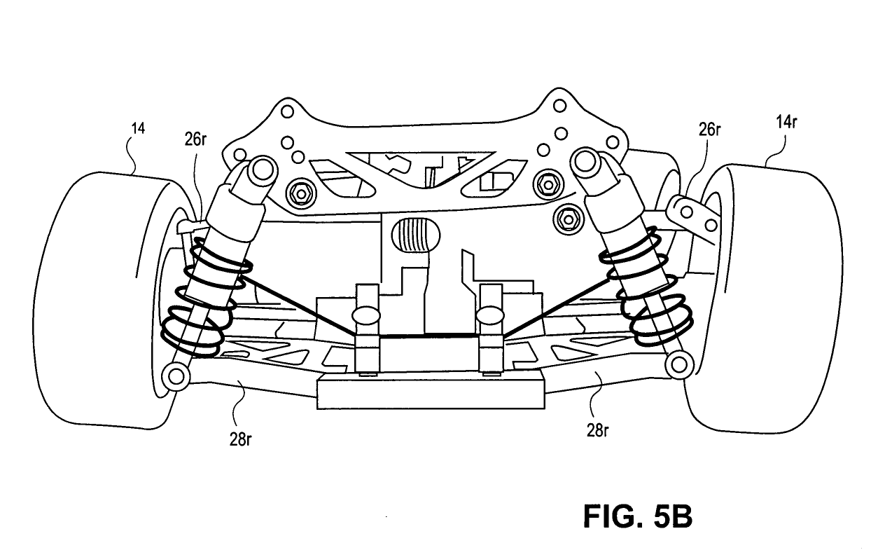

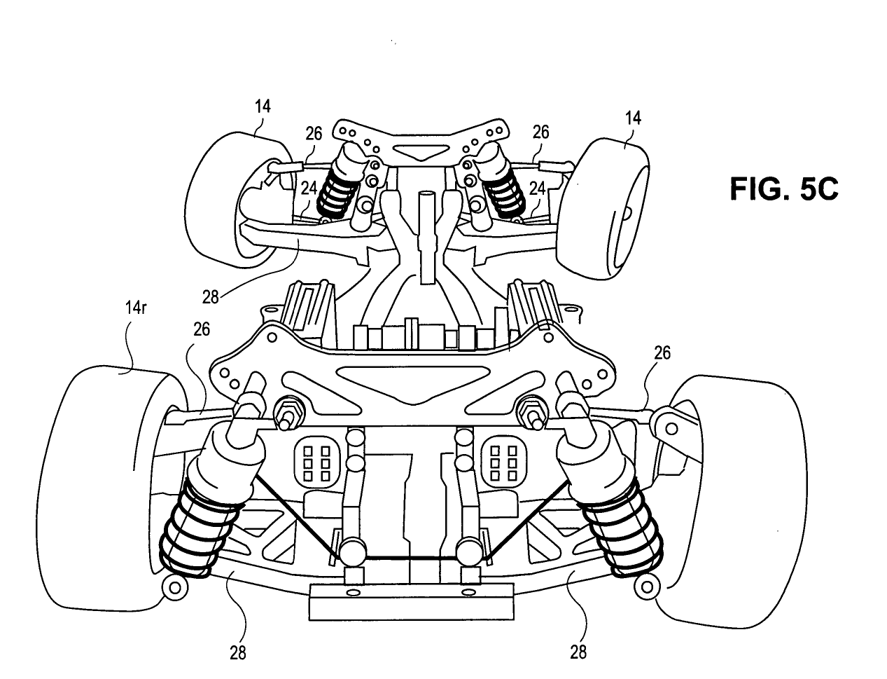

It will be understood, that wide variations in the proportional movement and direction of the respective linkages can occur. For example, the length of the lower link 28 can be very responsive to the movement of tie rod 24. Further, the lever arm from star wheel 40 of both tie rod 24 and upper link 26 can be altered to virtually any desired ratio. Additionally, as shown here, variation of camber of the steered wheel is responsive to movement of the steering mechanism. This same mechanism for variation of camber could as well be applied to the driven rear wheels of a four-wheel vehicle. This is illustrated schematically in FIGS. 5A, 5B and 5C, it being noted that although changes in camber are shown, a linkage between the steered wheels and the rear, non-steered wheels is omitted. The reader will understand that virtually any linkage will do. For example, by placing a star wheel 40 adjacent the non-steered wheels and linking to the front star wheel 40, camber could be imparted to the rear steered wheels. Similarly, servos and the like can impart the desired camber. As can be seen in FIGS. 5A, 5B and 5C, the respective rear wheels are labeled 14r, and upper link 26r and lower link 28r in the drawings.

Likewise, it will be understood that the steering mechanism here shown in the form of star wheel 40 is exemplary only. All kinds of steering mechanisms can respond to the linkage here shown. For example, rack and pinion steering could as well be used. These, and other variations of this invention can occur.

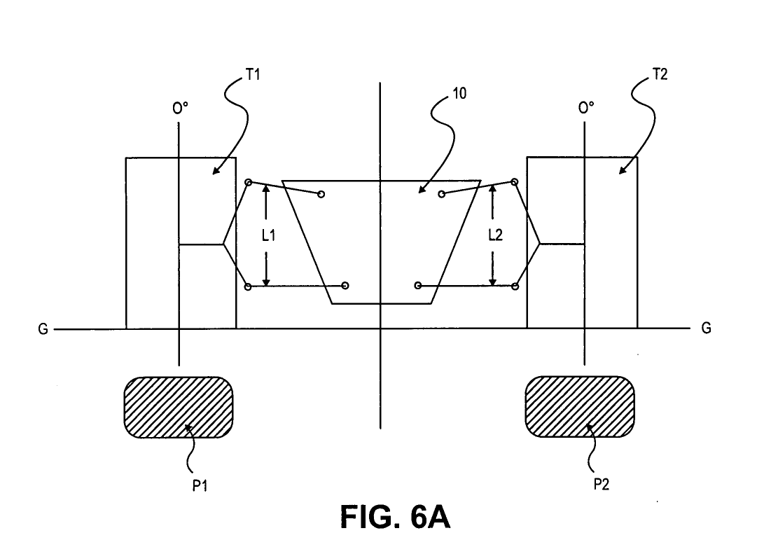

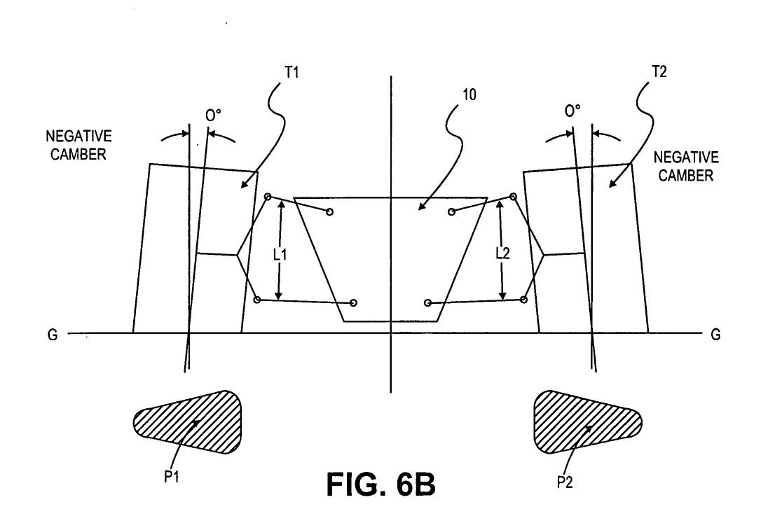

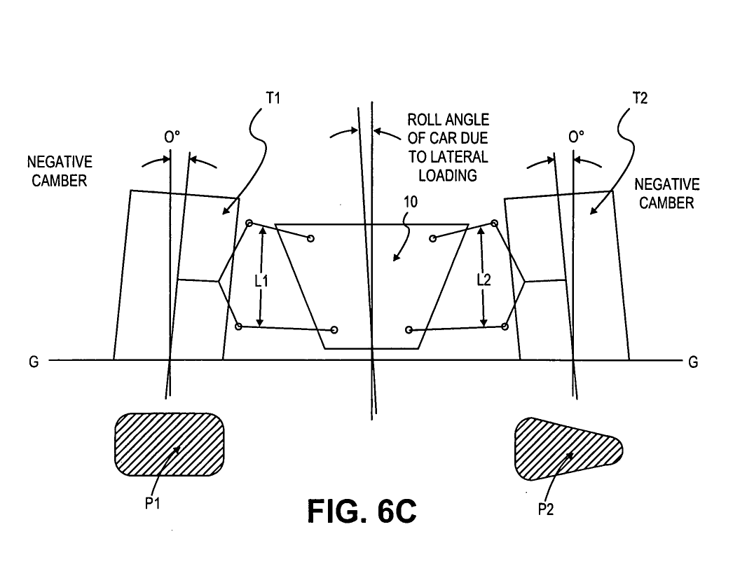

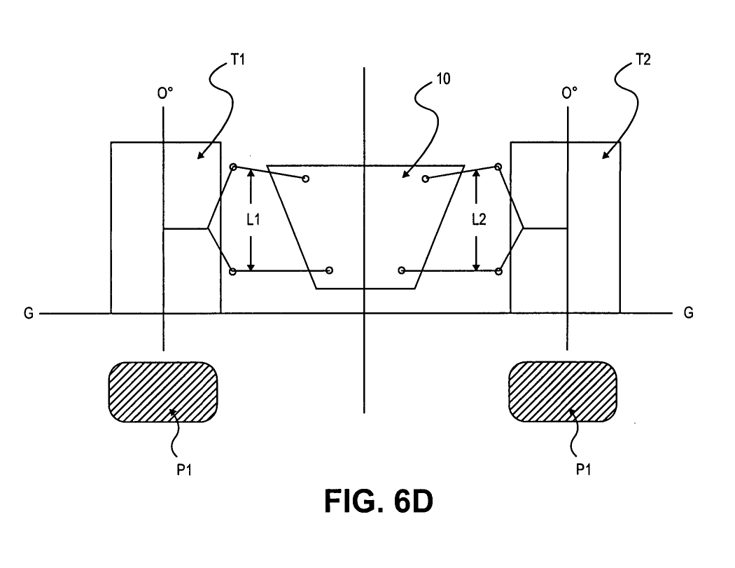

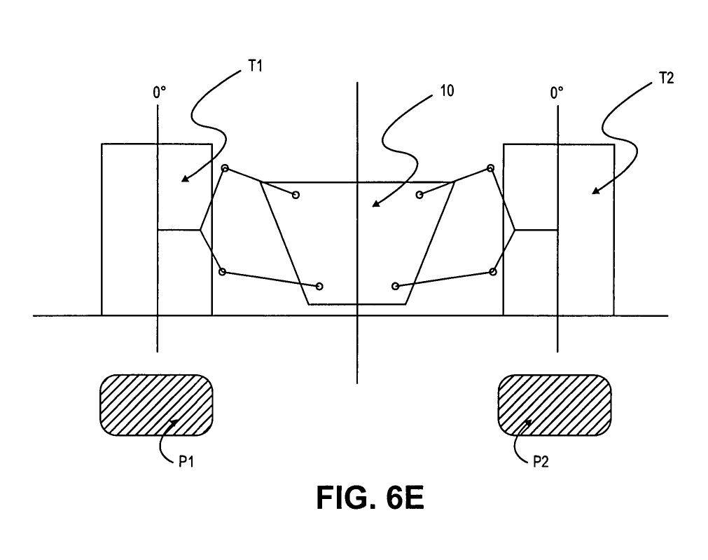

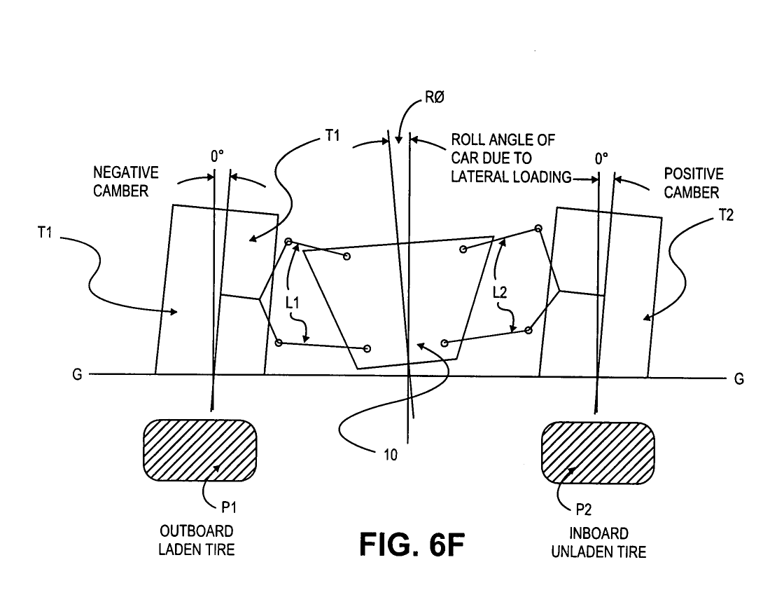

Referring to the prior art FIG. 6A, wheel assembly T1 is shown to be connected to vehicle 10 by linkage assembly L1. Likewise, wheel assembly T2 is shown to be connected to vehicle 10 by linkage assembly L2. Vehicle 10 is shown to be at rest or traveling at a constant velocity with no vertical or lateral loading. Contact patch P1 and P2 are the surface areas of tires T1 and T2 respectfully, making contact with road surface G as seen from below, as if road surface G were transparent. T1 and T2 is shown to be normal to the road surface, that is zero camber, and contact patches P1 and P2 are shown to have the maximum surface area making contact to road surface G.

Referring to the prior art FIG. 6B, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a vertical load. Contact patch P1 and P2 are the surface areas of tires T1 and T2 respectfully, making contact with road surface G as seen from below, as if road surface G were transparent. T1 and T2 is shown to be imparting negative camber, consequently altering contact patches P1 and P2 to triangular shaped surface areas making contact to road surface G, reducing the total surface area and thus providing less grip.

Referring to the prior art FIG. 6C, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a lateral load to the left. Contact patch P1 and P2 are the surface areas of tires T1 and T2 respectfully, making contact with road surface G as seen from below, as if road surface G were transparent. Tire T1 is laterally loaded and is shown to be imparting negative camber, and because of the distortions of tire T1's cross section and bending of linkage L1 caused by the lateral load and the subsequent rolling of the vehicle 10 by angle R0, consequently alters contact patch P1 to a rectangular shaped surface area making contact to road surface G, maximizing the grip for tire assembly T1. Tire T2 is unloaded and is shown to be imparting negative camber, altering contact patch P2 to a triangular shaped surface area making contact to road surface G, reducing the maximum grip for tire assembly T2.

Referring to FIG. 6D of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be at rest or traveling at a constant velocity with no vertical or lateral loading. Contact patch P1 and P2 are the surface areas of tires T1 and T2 respectfully, making contact with road surface G as seen from below, as if road surface G were transparent. T1 and T2 is shown to be normal to the road surface, that is zero camber, and contact patches P1 and P2 are shown to have the maximum surface area making contact to road surface G.

Referring to FIG. 6E of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a vertical load. Contact patch P1 and P2 are the surface areas of tires T1 and T2 respectfully, making contact with road surface G as seen from below, as if road surface G were transparent. T1 and T2 are shown to be normal to the road surface, that is zero camber, and therefore, contact patches P1 and P2 are unaffected and are shown to have the maximum surface area making contact to road surface G, providing the maximum possible grip.

Referring to FIG. 6F of this invention, wheel assembly T1 is shown to be connected to vehicle 10 by linkage assembly L1. Likewise, wheel assembly T2 is shown to be connected to vehicle 10 by linkage assembly L2. Vehicle 10 is shown to be experiencing a lateral load to the left. Contact patch P1 and P2 are the surface areas of tires T1 and T2 respectfully, making contact with road surface G as seen from below, as if road surface G were transparent. Tire T1 is laterally loaded and is shown to be imparting negative camber, and because of the distortions of tire T1's cross section and bending of linkage L1 caused by the lateral load and the subsequent rolling of the vehicle 10 by angle R0, consequently alters contact patch P1 to a rectangular shaped surface area making contact to road surface G, maximizing the grip for tire assembly T1. T2 is unloaded and is shown to be imparting positive camber, and because of the distortions of tire T2's cross section and bending of linkage L2 caused by the lateral load and the subsequent rolling of the vehicle 10 by angle R0, consequently alters contact patch P1 to a rectangular shaped surface area making contact to road surface G, maximizing the grip for tire assembly T2.

It will be understood that the change of camber of the wheels effectively changes the stability of a car to which this system is attached. When the tire is standing perpendicular or normal to the road surface, it has 0° of camber. This is shown in FIG. 6A. When the top of the tire is tilted in towards the car, it is said to have negative camber. This is shown in FIG. 6B. When the top of the tire tilts away from the center of the car, it has positive camber.

This is shown on T2 of FIG. 6F. When the tire experiences lateral loading, the tire's coefficient of friction or CF, varies with the change in camber, because of the cross sectional distortion it experiences. See FIG. 6F. For the outboard loaded or laden tire, the CF increases from 0° camber to negative camber, and decreases from zero to positive camber. When the tire is subjected to lateral loading with 0° camber, the contact patch distorts from the optimum surface area because of the deflection and bending of the suspension components and the distortion of the tire's cross section itself. Thus creating negative camber corrects the contact patches distortion, and restores the patch to optimum surface area, only on the laterally loaded tire. This is the reason to the increase in the CF with negative camber. Note this change in the CF relative to camber only applies to lateral loading and not vertical loading conditions. An optimum operation of the contact patch is shown in FIG. 6F

On vertical loading conditions, the tires must remain normal to the road surface, and any degree of camber is unfavorable, as it minimizes the contact patch of the tires, thus minimizing the grip capabilities of the tire. Specifically, each tire—either steered or non-steered—has a “contact patch” relative to the road. The contact patch is that portion of the tire that makes contact with the road. Moreover, most racing tires have a rectilinear cross-section at their periphery and point of contact to the road. Accordingly, and with a tire of rectilinear section, even a slight change of camber of the tire will shift the contact patch to the side of the tire and away from the center of the tire. The tendency of the new inventions ability to favorably change the camber angles depending on the tires' loading condition maximizes the amount of grip the tires can generate. Improved steering, stability, and most important, maximum grip will result.

1. In a vehicle steering system having the combination of;
a wheel to be steered,
a steering spindle for mounting the wheel to be steered for rotation about a generally vertical plane,
a steering knuckle,
a vertical kingpin through the steering knuckle for a vertically pivoting the steering spindle relative to the steering knuckle to enable turning of the wheel to be steered,
an upper link pivoted at a first end to the steering knuckle and pivoted at a second end to the vehicle;
a lower link pivoted at a first end to the steering knuckle and pivoted at a second end to the vehicle;
a steerage linkage assembly including the tie rod for a movement with the vehicle steering system and a tie rod arm for rotating with the steering spindle about the vertical kingpin,
whereby movement of the tie rod by the vehicle steering system correspondingly moves the tie rod arm in rotation to steer the vehicle,
the improvement to the vehicle steering system comprising:
a linkage between the vehicle steering system and links to change the extension of at least one of the links relative to the vehicle whereby the camber of a wheel is changed responsive to movement of the steering system.

2. The vehicle steering system of claim 1 and wherein:
the linkage between the vehicle steering system and links changes the extension of the upper link relative to the vehicle.

3. The vehicle steering system of claim 1 and wherein:
the lower link is connected to the vehicle suspension system.

4. The vehicle steering system of claim 1 and wherein:
the lower link is triangular in plan having an apex and a base with the apex connected at the steering knuckle and the base connected at the vehicle.

5. The vehicle steering system of claim 1 and wherein:
the camber is changed at a steered wheel.

6. The vehicle steering system of claim 1 and wherein:
the camber is changed at a non-steered wheel.
